(19) United States
(12) Patent Application Publication
(10) Pub. No.: US 2007/0051348 A1
(43) Pub. Date: Mar. 8, 2007

(54) Centrifugal engine charger driven by combined gearing system for multi speed operation and a method of power transmission

(75) Inventor: Rajeev Siddaramappa Hundekar, Bangalore (IN)

Correspondence Address: BIRCH STEWART KOLASCH & BIRCH, PO BOX 747, FALLS CHURCH, VA, 22040-0747, US

(73) Assignee: Presusse Indian (P) :td, Bangalore (IN)

(21) Appl. No.: 10/553,787

(22) PCT Filed: Apr. 21, 2004
(86) PCT No.: PCT/IN04/00111

§ 371 Date: Sep. 5, 2006

(30) Foreign Application Priority Data
Apr. 21, 2003 (IN) 239/MAS/2003

(51) Int. Cl. F02B 33/00

(52) U.S. Cl. 123/559.1; 123/559.3

(57) ABSTRACT

The present invention provides a centrifugal engine charger for internal combustion engines (IC Engines) driven by a plurality of gear drives comprising eccentric and planetary drives to provide variable speed drive to an engine. The present invention also provides a method of power transmission to the engine charger.

### TECHNICAL FIELD

The present invention relates to a Centrifugal Engine Charger for Internal Combustion Engines (IC Engines) driven by a plurality of gear drives comprising eccentric and planetary drives to provide variable speed drive to an engine. The present invention also provides a method of power transmission to the engine charger.

### BACKGROUND AND PRIOR ART

An Internal Combustion (IC) Engine may be driven either in the suction mode or supercharging/turbo charging mode. In order to increase the performance of an IC Engine which is Naturally Aspirated (NA) it is common to supercharge or turbocharger. The currently used engine chargers are effective either at the Low engine speeds expressed in revolutions per minute (rpm) or at the Higher Engine speeds, but not on the entire spectrum of the Engine Operating Speed. The existing systems have a fixed ratio by virtue of which the output rpm of the engine charger is directly proportional to the Engine RPM from where the drive is obtained.

For instance, when a Supercharger is tuned for Low RPM of Engine, the transmission ratio of the drive from the Engine RPM to Output RPM of the supercharger has to be so set that the Compressor is effective in generating the required Pressure Ratio/Boost at the low rpm of engine, which means a higher transmission ratio of the order of above 20:1 and more. For instance, with a ratio of 35:1, at lower ranges of engine speed of 1000 rpm, the output of the gearbox spins @ 35000 rpm, and as the engine speed increases to 5000 rpm the output shaft spins @175000 rpm.

As a result of such a high rpm the following series of problems are encountered viz., reduction in life of bearings, vibrations of supercharger unit, Exponential rise in Cost factor, undesired Higher Pressure ratios, rise in supercharger/engine temperatures leading to increased NOₓ emission problems.

In order to overcome these problems, at higher engine rpm, either a bypass valve is used to cut off the air induction into the engine or the supercharger is disabled with help of the clutch, which leaves the engine as just a Naturally Aspirated. In other words, the purpose of supercharging is defeated since it cannot be used on the entire operating cycle of engine.

On the other hand, if a Supercharger is Tuned to a Higher RPM of Engine, in such a case, the transmission ratio of the drive from the Engine rpm to output rpm of the supercharger has to be so set that the Compressor is effective in generating the required Pressure Ratio/Boost at the higher rpm of engine, resulting in a relatively lower transmission ratio of the order of for example 15:1. With this ratio at higher ranges of engine speed of such as 4000 rpm to 5000 rpm, the output of the gearbox spins @ 60000 to 75000 rpm which is for certain applications, an effective range for getting the required boost, but nevertheless while as the engine speed decreases (as in most of city drive conditions-Stop & Go) to levels of 1000 to 1500 the output shaft spins @15000 to 22500 rpm. Such a low engine speed with such a gear ratio is inadequate for the compressor to be effectively efficient while on the contrary results in generating higher levels of smoke emission at acceleration and also results in lower torque, further resulting in discomfort in driving.

The demand for use of a smaller engine to deliver a given power and torque in turn demands a solution through an engine charger which must be by itself more compact, ultra light and efficient. Hence, a supercharger with multi-speed gear arrangement, obtained with two planetary gear sets, is used to provide a high and low gear ratio, while to supercharge a smaller engine in the range of 800 to 1200 cc, a smaller compressor has to be used and to provide the necessary boost by such smaller compressor, at such low engine speeds, a very high gear ratio of the gearing system is required. The application of planetary gear system to support such higher gear ratio in the range of 40:1 without a compromise on the size of the gearing is fairly limited.

DE19918533 teaches a circular sliding gear acting as parallel shaft reduction gear.

### OBJECT OF THE PRESENT INVENTION

The main object of the present invention is to provide a centrifugal engine charger for IC engines with plurality of multi-speed gear system.

An object of the present invention is to provide a centrifugal engine charger with gear combination of eccentric and planetary gears.

Another object of the invention is to provide a centrifugal engine charger that can adapt to both low and high input rpm of an IC engine.

Yet another object of the present invention is to provide a compact centrifugal engine charger that can deliver the desired power and torque for small and larger engines.

Still another object of the present invention is to provide a method for optimum power transmission in automobiles by using such a centrifugal engine charger.

### SUMMARY OF THE INVENTION

The present invention provides a Centrifugal Engine Charger for Internal Combustion Engines (IC Engines) driven by a plurality of gear drives comprising eccentric and planetary drives. The Eccentric drive has a set of ring gear (internal gear) and a sun gear(external gear). The Sun gear is mounted on three eccentric shafts rotating freely about their own axis wherein the central shaft is used to deliver the rotational output RPM to the rotor of the engine charger, the sun gear by itself does not rotate but keeps shifting continuously along the circumference of the ring gear which gets the rotary input from the engine through the Ring Gear. The Planetary drive has a ring gear, a set of planetary gears and sun gear mounted on a fixed carrier. The planetary drive has a rotary input from the engine and the output is connected to the rotor of the engine charger.

Both Eccentric drive and Planetary drive have an output to supply torque to the rotor of the engine charger. In such a combination of eccentric and planetary drive, the eccentric drive usually has a High gear ratio and the planetary has a low gear ratio. The embodiment also includes the shifting mechanism through an electronically or non-electronically controlled clutching system that can be used to shift between higher & lower gear ratios. It also includes clutching/declutching system to drive/connect the output from either drive to the rotor shaft of engine charger.

In the eccentric drive, it gets the torque input to its ring gear which supplies torque to sun gear which in turn drives the rotor shaft of the engine charger. In the planetary drive, the torque input is given to the ring gear, which in turn supplies torque to the set of planetary gears which in turn supply torque to the sun gear which drives the rotor shaft of the engine charger.

The present invention also provides a method for boosting adequately the pressure of inlet air(charge) supplied to an IC Engine by an engine charger said method comprising supplying of the drive or transmission for the engine charger which is a combination-drive, a combination of drive with high gear ratio and drive with a low gear ratio, wherein the engine charger is driven by high gear ratio drive (eccentric drive) at lower engine speeds or RPM levels or below a pre-determined level of engine RPM, while engine charger is driven by low gear ratio drive(planetary drive) at higher engine speeds/RPM levels or above a pre-determined level of engine RPM, thereby providing a multi-level, variable torque to the rotor of engine charger.

### BRIEF DESCRIPTION OF THE ACCOMPANIED DIAGRAMS

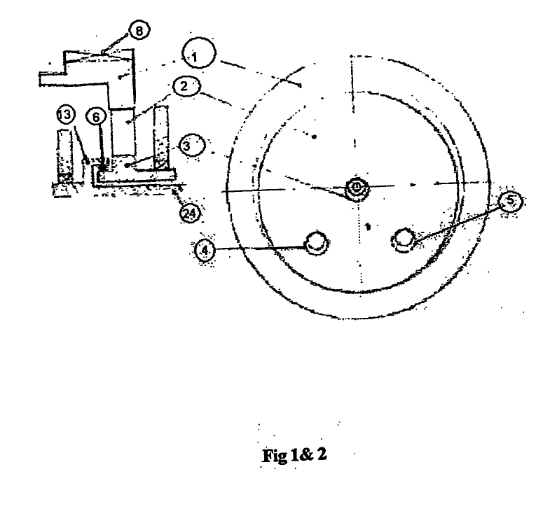

FIG. 1 is a cross sectional side view of an embodiment of the eccentric drive of the present invention showing the gears engaged and other surrounding parts when the engine is operating at lower speeds or below a pre-determined level of engine speed.

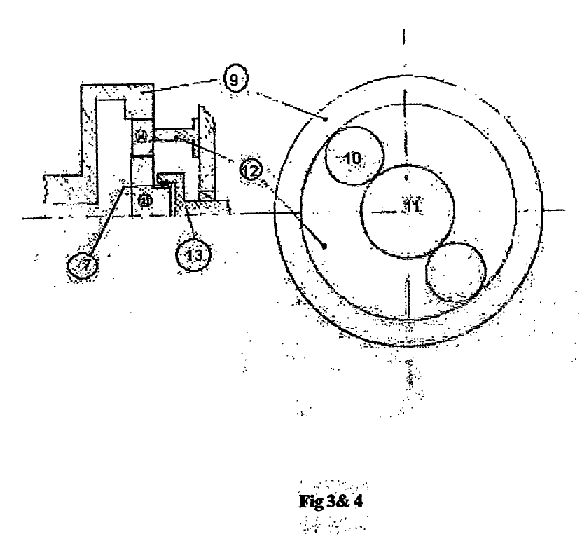

FIG. 2 is a front view of the embodiment shown in FIG. 1 showing the layout of the gears in the eccentric drive engaged in the lower speeds of the engine.

FIG. 3 is a cross sectional side view of an embodiment of the planetary drive showing the gears engaged and other surrounding parts when the engine is operating at higher speeds or above a pre-determined level of engine speed.

FIG. 4 is a front view of the embodiment shown in FIG. 3 showing the layout of the gears engaged in the planetary drive used during the higher engine speeds or above a pre-determined speed of the engine.

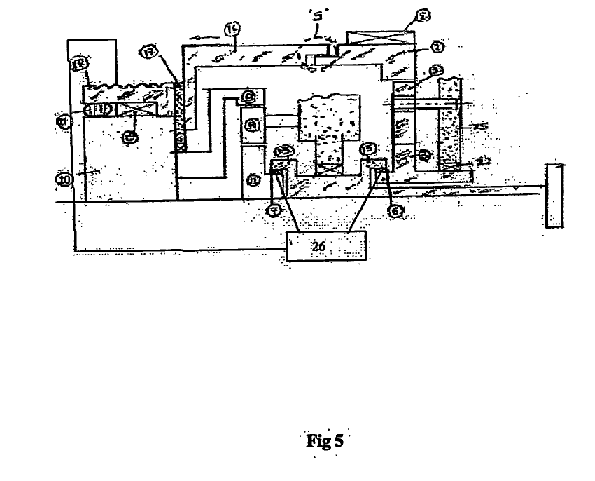

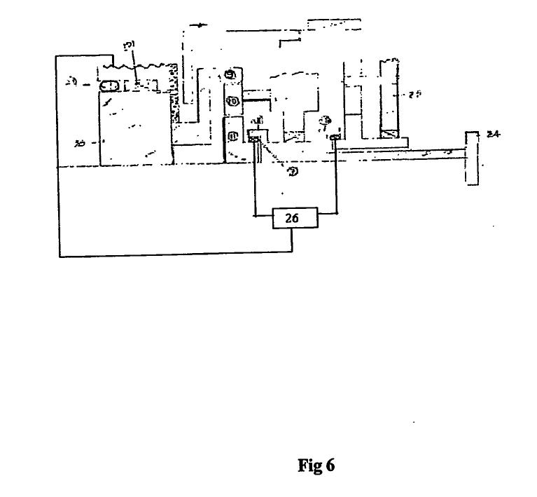

FIG. 5 is a cross sectional view of the embodiment of the combination/multi speed drive of the present invention showing the schematic drawing of the system engaged through the clutching in Lower Engine speeds i.e. with higher gear ratio.

FIG. 6 is a cross sectional view of the embodiment of the combination/multi speed drive of the present invention showing the schematic drawing of the system engaged through the clutching in Higher Engine Speeds i.e. with lower gear ratio.

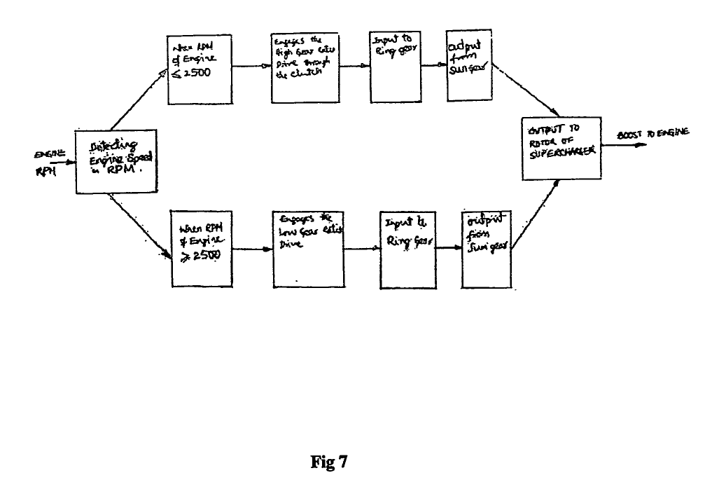

FIG. 7 is a Flow Chart of steps & levels of actions taking place in the present invention.

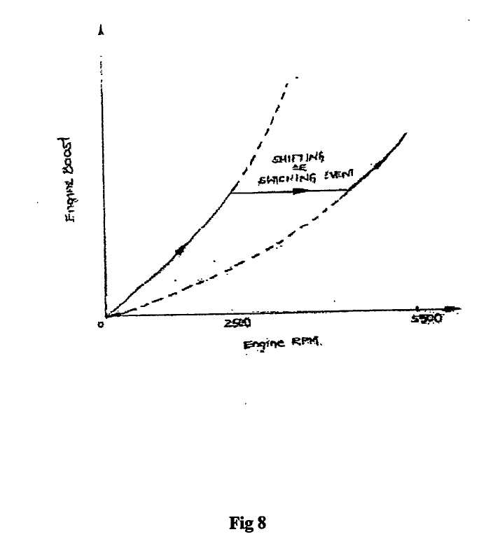

FIG. 8 is a graphical representation of the typical shifting activity between the two drives in relation to the engine speeds & the corresponding boost delivered to the inlet of the IC engine.

### DETAILED DESCRIPTION OF THE INVENTION

The present invention provides a centrifugal engine charger for IC engines through a multi speed drive. The supercharger receives input torque from the engine through a belt and pulley/clutch system connected to the crankshaft of the engine. The arrangement of the combination of drives of the present invention (of which at least one is eccentric & the other may be planetary) enables to design and produce a supercharger of light weight, a more silent, adequately compact with better efficiency in providing adequate boost to engine by boosting pressure of the air at the inlet which in turn allows generation of more specific power at much lower fuel consumption and drastically reduces smoke emission at acceleration. The drive arrangement of the present invention allows the superchargers to receive the torque input from the engine and step up exponentially to deliver the higher rpm to the rotor of the engine charger which allows compressing the air more efficiently. The preferred embodiments of the present invention are explained initially by referring to FIG. 1 and FIG. 2. The gears of the eccentric drive are shown schematically and the shape of the gear teeth is not shown. Any compatible shape and size of the gear can be adopted in the present invention. When the gears are engaged or meshed as mentioned in this document, the teeth of one gear is in mesh with the teeth of the mating gear by which both torque and rotary motion is being transferred from one gear to the next.

The ring gear 1 with a teeth profile is meshed with the teeth profile of sun gear 2, which is mounted on three pins/shafts 3, 4, & 5 which all rotate eccentric about their axis but the eccentricity of all the three shafts is equal and unidirectional in angular position. The Sun Gear 2 does not rotate about its axis but continuously shifts along the circumference of the internal teeth of the Ring Gear 1 as the ring gear rotates. Thus the ring gear drives the eccentric shaft 3 through sun gear 2 which allows the increase of rotational speed supplied to ring gear from the engine in the form of RPM to the pre determined ratio at the output end of shaft 3 which is significantly higher than the input RPM and which can be used to drive the output shaft 13 & rotor 24 of the supercharger.

Referring to the FIG. 3 & FIG. 4, a preferred embodiment of the present invention is shown. The present invention preferably includes a second drive which may be a planetary drive of a lower gear ratio as compared to the eccentric drive. The planetary drive consists of a ring gear 9, and a set of planetary gears 10 which are mounted on a carrier 12, and a Sun gear 11 within the ring gear 9. The planetary gear set shown in the figures, similar to the eccentric drive allows increasing the rotational motion supplied to the ring gear in the form of RPM from the engine to a much higher pre-determined ratio and utilizing this output to drive the output shaft 13 & 24 of the supercharger.

Referring now to FIGS. 1, 2 & 5, a preferred embodiment of the present invention is shown with the shifting mechanism—the clutching system in operation. The FIG. 5 shows the system of the present invention in a higher gear ratio i.e. when the eccentric drive is engaged such that the rotational motion from the engine is increased more steeply than when the planetary drive which is of lower gear ratio is engaged. The preferred embodiment of the present invention includes two clutch systems, one to engage/switch between the gear drives of higher & lower gear ratios and the other clutch system preferably a centrifugal clutch set to engage at a pre determined RPM between the shaft 3 of eccentric drive and rotor 13 or between the sun gear 11 of planetary drive and common output shaft 13. As shown in the FIG. 5 the clutching system consists of an electromagnetic coil 19 which is operated by the electrical input. The face plate 17 of the clutch has a surface which is made of special coated material so as to offer friction to the section 16 of ring gear 1 to hold it tight in position for efficient transfer of torque from pulley of clutch to the ring gear 1.

When the coil in the clutch is activated by the electrical current, the surface of plate 17 attracts magnetically the section 16 of ring gear 1 which slides along the axial splines at area shown as S and the ring gear 1 is driven which in turn drives the sun gear 2 and as the sun gear shifts circumferentially along the internal diameter of the ring gear the eccentric shaft 3 on which the sun gear 2 is mounted, rotates with an increased ratio of the gear ratio of the drive. The eccentric central shaft 3 is a hollow shaft through which the common output rotor shaft passes and on this shaft the impeller 24 of the supercharger is mounted. As shown in the Fig the shaft 3 engages with common output shaft 13 with the help of a clutch preferably a centrifugal clutch 6 which engages at a pre-determined RPM. As the rotor 13 gets the drive from sun gear 2, the rotor drives the impeller of supercharger 24. As the Electromagnetic clutch is a one way clutch, when engaged by the face plate 17 it overruns and is disengaged with inner pulley 20 through a one way mechanism 21 leaving the planetary drive disengaged from input.

Referring now to FIGS. 3, 4 & 6 which show the low gear ratio mode when no current is supplied to the coil of the clutch and section 16 (FIG. 5) of ring gear 1 (FIG. 5) is out of contact with face plate 17 (FIG. 5) and when face plate 17 (FIG. 5) is not loaded the one way mechanism 21 engages the inner pulley 20. In this mode, the torque is supplied from outer pulley 18 to inner pulley 20 & to the ring gear 9 which is in mesh with set of planetary gears 10. The set of planetary gears 10 supply torque to the sun gear 11 which when rotates at a pre-determined RPM engages with the common output shaft 13 with help of a clutching mechanism 7 preferably a electromagnetic/centrifugal type. This common output shaft 13 is connected with rotor 24 of the supercharger. When the drive in the low gear ratio is engaged, the other drive is disengaged both through the mechanism 21 & clutch system 6. The ratio of the drive is obtained by dividing the number of teeth on the ring gear 9 by the number of teeth on the sun gear 11.

A default fail-safe feature is incorporated into the system of present invention to prevent any damage to the gears, bearings, shafts, seals etc. In case of failure of electrical signals to the clutch during operation at high gear ratio mode, the system immediately returns to the low gear ratio mode. The other clutching mechanism 6 & 7 at two ends of common output shaft 13 are electromagnetic/centrifugal type and get engaged only when the sun gears cross the pre-determined RPM levels and due to the fact that when one gear drive is in engagement, the other is idling at any given point of time, the drive to the rotor is from only one input which ensures the safety and also higher efficiency of the system by virtue of lower losses of energy.

All the clutching mechanisms are controlled by an Electronically Controlled Unit (ECU) 26. This ECU gets the input signals from the engine management system with parameters such as engine rpm, load, power, intake air pressure, intake air temperature etc. The ECU processes all the inputs to determine an optimum point at which an output signal is sent to each of the clutch of the supercharger to provide an adequate boost to the engine over the entire operating speeds of the engine. The high gear ratio is preferably activated when the engine RPM is in lower range for example below 2500 RPM, but this number could be adjusted depending on the engine characteristics and desired results. This allows the high gear ratio drive to provide a higher level of RPM to the supercharger when the engine RPM is lower. The higher level of supercharger RPM provides adequate boost to the engine. Once the engine reaches the predetermined RPM for example 2500 RPM, the ECU disengages the clutch from high gear ratio due to which a shifting event occurs which engages the drive of low gear ratio. As the engine RPM crosses & operates above a predetermined level (2500 RPM), due to the engagement of low gear ratio, the output RPM of the supercharger is maintained at the desired level as in high gear ratio mode to provide adequate boost to the engine and this shifting event avoids otherwise undesired boost from the compressor of the supercharger arising out of higher gear ratio at higher engine speeds. Thus the electronically controlled clutching mechanism in tandem with multi speed drive allows the method of present invention to deliver variable torque to the rotor 24 of the centrifugal supercharger to vary the amount of boost supplied to the engine as per the requirements of the engine.

It should be noted that there could be wide range of changes made to the present invention without departing from its scope. A combination of two eccentric drives, one of high gear ratio & other of low gear ratio can also be used without the use of planetary drive. More sets of eccentric drive or planetary drive could be utilized to obtain more than two levels of gear ratios in the system. The configuration of number of teeth and the size of the gears may be adjusted depending on the engine & the desired boost and other results from supercharging. The clutching systems and their positioning can also be of different types known in the prior art. Thus it is intended that the foregoing detailed description be treated as only illustrative rather than limiting and that it be understood that it is the following claims, including all equivalents, which are intended to define the scope of the invention.

Accordingly, an embodiment of the present invention, wherein a centrifugal engine charger for Internal Combustion (IC) Engines driven by a combined gear arrangement for multi-speed operation, said centrifugal engine charger comprising:

an electromagnetic coil disposed in the clutch to receive signal from an electronic control unit, a pulley means to receive input torque from the engine, a one-way clutch disposed between said electro-magnetic coil and pulley to act as a switch in activating either said coil or pulley, a metallic face plate disposed adjacent to said coil to receive activation from magnetic coil, a ring gear with a pair of sliding engagement members connected to each other by means of an axial spline, one of said members comes in magnetic contact with the face plate on receiving activation from the coil via face plate and the other in rotary communication with a ring gear of an eccentric gear drive, an eccentric gear drive, said eccentric gear drive further comprising an external circular rotating ring gear with a suitable tooth profile on its inner surface, a plurality of shaft members placed at equal distance from each other with one shaft placed at the central axis of said ring gear and the other shafts placed at equal distances, a sun gear is housed in the ring gear by way of mounting the same on the shaft members with its teeth profile meshed with teeth profile of the ring gear to have a centrifugal rotary motion, said sun gear provides a rotary motion to the central shaft, a centrifugal clutch in conditional contact with the central shaft on one side and a rotor shaft of the engine on the other side subject to a pre-determined rpm, said rotor shaft driving an impeller of the engine charger, a planetary gear drive of low gear ratio, said planetary gear activated by the pulley in conjunction with the one-way clutch in absence of electrical signal from the coil, said planetary gear further comprising, an external circular rotating ring gear with a suitable teeth profile on its inner surface, a carrier disposed inside said ring gear, a pair of planetary gears mounted on said carrier, a sun gear is meshed in between said planetary gears, said planetary gears transmit rotary motion obtained from said ring gear to the sun gear, a centrifugal clutch in conditional contact with the sun gear on one side and the rotor shaft of the engine on the other side subject to a pre-determined rpm, said rotor shaft driving an impeller of the engine charger,

An embodiment of the present invention, wherein the one-way clutch disengages either pulley or the face plate subject to the supply of electrical signals to the magnetic coil.

Another embodiment of the present invention, wherein the metallic face plate is coated with a ceramic material to provide friction to engaging member of the ring gear.

Yet another embodiment of the present invention, wherein the combination of gear drives is selected from a combination of planetary, eccentric, cycloidal, orbiting or other conventional gear drives.

Still another embodiment of the present invention, wherein one of the gear drives is an eccentric gear drive.

It is also an embodiment of the present invention, wherein a plurality of combination of planetary and eccentric drives is also used to achieve multiple levels of gear ratios.

Yet another embodiment of the present invention, wherein the shaft members of the eccentric gear drive are preferably positioned in the form of an equilateral triangle with the central shaft on the central axis of the eccentric gear drive.

Further embodiment of the present invention, wherein the central shaft is a hollow shaft connected to the rotor shaft of the charger through the centrifugal clutch member.

The present invention also provides a method for optimum power transmission to an engine by using charger of claim 1, said method comprising the steps of; receiving input torque of engine through a conveyor belt, transmitting electrical signal from Electronic Control Unit (ECU) to the magnetic coil, magnetizing the face plate and attracting the engaging member to provide axial slide motion, transmitting the axial sliding motion into rotary drive to activate the eccentric gear drive to provide a high gear ratio for low engine speeds, sensing and comparing the low engine rpm of the engine with the rpm of the central shaft of the sun gear to activate the centrifugal clutch, transmitting the low speed input torque to the rotor of the engine charger resulting in desired rotor speed, terminating the electrical signals to the magnetic coil whenever the rpm is beyond the threshold value, activating the pulley member by one-way clutch to provide low gear ratio in conjunction with the planetary gear drive for high engine speeds, transmitting the high speed input torque to the planetary gear drive through the pulley member, sensing and comparing the high engine rpm of the engine with the rpm of the sun gear to disconnect the central shaft of the eccentric gear from the rotor shaft at high rpm, activating the centrifugal clutch to provide higher speed to the engine charger, and repeating the steps of activation and deactivation of centrifugal and one-way clutch to provide a desired rpm of high and low speed to the engine charger.

An embodiment of the present invention, a method wherein the threshold rpm is in the mid range of total operating range of rpm of the engine.

Another embodiment of the present invention, a method wherein at a given point of time only one gear drive is engaged to provide safety and higher efficiency.

Yet another embodiment of the present invention, a method wherein switching of low and high gear drives is performed depending upon the rpm of the engine to provide optimum rpm to the engine.

Still another embodiment of the present invention, a method wherein a desired output rpm is provided on variable input rpm.

Advantages

1. The engine charger of the present invention provides enhanced torque and power for a given size if an IC Engine.
2. The engine charger of the present invention provides enhanced fuel efficiency without compromising much on the engine power.
3. The engine charger of the present invention provides better torque and power at all the levels of operating cycle of an engine.
4. The engine charger of the present invention provides an enhanced thermal efficiency of an engine system and further substantially reduces the pollution levels of, more particularly Particulate Matter (Smoke) and more particularly at acceleration where normally the present engines have maximum smoke emission.
5. The engine charger of the present invention is of very compact, lightweight and silent performer.
6. The engine charger of the present invention provides enhanced torque and power with better efficiency for smaller vehicles/engines due to its compactness and ability to spin at very high rpm.

1-12. (canceled)

13. A centrifugal engine charger for Internal Combustion (IC) Engines driven by a combined gear arrangement for multi-speed operation, said centrifugal engine charger comprising:
a) an electromagnetic coil disposed in the clutch to receive signal from an electronic control unit,
b) a pulley means to receive input torque from the engine,
c) a one-way clutch disposed between said electro- magnetic coil and pulley to act as a switch in activating either said coil or pulley,
d) a metallic face plate disposed adjacent to said coil to receive activation from magnetic coil,
e) a ring gear with a pair of sliding engagement members connected to each other by means of an axial spline, one of said members comes in magnetic contact with the face plate on receiving activation from the coil via face plate and the other in rotary communication with a ring gear of an eccentric gear drive,
f) an eccentric gear drive, said eccentric gear drive further comprising an external circular rotating ring gear with a suitable tooth profile on its inner surface, a plurality of shaft members placed at equal distance from each other with one shaft placed at the central axis of said ring gear and the other shafts placed at equal distances, a sun gear is housed in the ring gear by way of mounting the same on the shaft members with its teeth profile meshed with teeth profile of the ring gear to have a centrifugal and circumferential rotary motion, said sun gear provides a rotary motion to the central shaft,
g) a centrifugal clutch in conditional contact with the central shaft on one side and a rotor shaft of the engine on the other side subject to a pre-determined rpm, said rotor shaft driving an impeller of the engine charger,
h) a planetary gear drive of low gear ratio, said planetary gear activated by the pulley in conjunction with the one-way clutch in absence of electrical signal from the coil,
i) said planetary gear further comprising, an external circular rotating ring gear with a suitable teeth profile on its inner surface, a carrier disposed inside said ring gear, a pair of planetary gears mounted on said carrier, a sun gear is meshed in between said planetary gears, said planetary gears transmit rotary motion obtained from said ring gear to the sun gear,
j) a centrifugal clutch in conditional contact with the sun gear on one side and the rotor shaft of the engine on the other side subject to a pre-determined rpm, said rotor shaft driving an impeller of the engine charger.

14. The engine charger of claim 13, wherein the one-way clutch disengages either pulley or the face plate subject to the supply of electrical signals to the magnetic coil.

15. The engine charger of claim 13, wherein the metallic face plate is coated with special ceramic material to provide friction to engaging member of the ring gear.

16. The engine charger of claim 13, wherein the combination of gear drives is selected from a combination of planetary, eccentric, cycloidal, orbiting or other conventional gear drives.

17. The engine charger of claim 16, wherein one of the gear drives is an eccentric gear drive.

18. The engine charger of claim 16, wherein a plurality of combination of planetary and eccentric drives is also used to achieve multiple levels of gear ratios.

19. The engine charger of claim 13, wherein the shaft members of the eccentric gear drive are preferably positioned in the form of an equilateral/isosceles triangle with the central shaft on the central axis of the eccentric gear drive.

20. The engine charger of claim 13, wherein the eccentric shaft members of the eccentric gear drive carry the ring gear which is driven by the Sun Gear.

21. The engine charger of claim 13, wherein the central shaft is a hollow shaft connected to the rotor shaft of the charger through the centrifugal clutch member.

22. A method for optimum power transmission to an engine by using charger of claim 13, said method comprising the steps of;
(a) receiving input torque of engine through a conveyor belt,
(b) transmitting electrical signal from Electronic Control Unit (ECU) to the magnetic coil,
(c) magnetizing the face plate and attracting the engaging member to provide axial slide motion,
(d) transmitting the axial sliding motion into rotary drive to activate the eccentric gear drive to provide a high gear ratio for low engine speeds,
(e) sensing and comparing the low engine rpm of the engine with the rpm of the central shaft of the sun gear to activate the centrifugal clutch,
(f) transmitting the low speed input torque to the rotor of the engine charger resulting in desired rotor speed,
(g) terminating the electrical signals to the magnetic coil whenever the rpm is beyond the threshold value,
(h) activating the pulley member by one-way clutch to provide low gear ratio in conjunction with the planetary gear drive for high engine speeds,
(i) transmitting the high speed input torque to the planetary gear drive through the pulley member,
j) sensing and comparing the high engine rpm of the engine with the rpm of the sun gear to disconnect the central shaft of the eccentric gear from the rotor shaft at high rpm,
(k) activating the centrifugal clutch to provide higher speed to the engine charger, and
(l) repeating the steps of activation and deactivation of centrifugal and one-way clutch to provide a desired rpm of high and low speed to the engine charger.

23. The method of claim 21, wherein at a given point of time only one gear drive is engaged to provide safety and higher efficiency.

24. The method of claim 21, wherein switching of low and high gear drives is performed depending upon the rpm of the engine to provide optimum rpm to the engine.

25. The method of claim 21, wherein a desired output rpm is provided on variable input rpm.
